(19) United States
(12) Patent Application Publication
(10) Pub. No.: US 2003/0163397 A1
(43) Pub. Date: Aug. 28, 2003

(54) Method of replacing vehicle windows in view of warranty claims

(76) Inventors: Craig Mayo, Farmington Hills, MI (US); Steve Baker, Cleveland Heights, OH (US)

Correspondence Address: NIXON & VANDERHYE P.C., 8th Floor, 1100 North Glebe Road, Arlington, VA, 22201, US

(21) Appl. No.: 10/083,637

(22) Filed: Feb. 27, 2002

(51) Int. Cl. G06F 17/60

(52) U.S. Cl. 705/34

(57) ABSTRACT

A method of handling vehicle window warranty claims, and replacing vehicle windows accordingly, is provided in order to reduce the amount of improper warranty costs realized by vehicle manufacturer(s). In certain example embodiments, a glass expert and/or technician at a retailer location analyzes damaged vehicle windows and makes a determination as to the likely cause of the damage (i.e., whether or not it is covered by the warranty). The warranty claim is processed based upon the result of the glass expert's determination.

This invention relates to a method of replacing vehicle windows (e.g., vehicle windshields, backlites, and/or sidelites) responsive to warranty claims. More particularly, this invention relates to a method of addressing vehicle window warranty claims by first determining the cause of the window damage, and thereafter replacing the window and billing an appropriate one of a plurality of parties based upon the cause of the window damage.

### BACKGROUND OF THE INVENTION

Vehicles (e.g., cars, trucks, sport utility vehicles, etc.) commercially sold typically have a manufacturer warranty which covers certain damage to windows of the vehicle. An example warranty may last for 3 years and/or 36,000 miles in certain instances. In other instances, the warranty may be a 12 months/12,000 miles warranty, or any other suitable warranty. However, manufacturer warranties do not cover all types of window damage.

For example, according to certain example manufacturer warranties available today, stress or strain fractures in a vehicle windshield with no obvious point of any object impact are legitimate warranty claims intended to be covered by the manufacturer warranty. This is because stress or strain fractures in a vehicle window (e.g., windshield) are often caused by improper window installation by the vehicle manufacturer on the vehicle assembly line (example vehicle manufacturers include Daimler-Chrysler, Ford, General Motors, Audi, Volkswagen, BMW, and the like). Another example window problem/issue intended to be covered by the manufacturer warranty is the presence of significant air bubble(s) (e.g., in a vehicle windshield). The presence of air bubbles is often caused at the windshield manufacturer which, after making the windshield, sells the same to the vehicle manufacturer for subsequent installation into the vehicle on the vehicle assembly line (example windshield manufacturers include Guardian Industries, PPG, Sekurit, Asahi, and Pilkington).

However, other types of vehicle window damage such as impact damage (e.g., damage caused by a rock/stone hitting a vehicle windshield during vehicle operation) are not intended to be covered by the manufacturer warranty. Instead, such other types of damage (e.g., impact damage) are the responsibility of the vehicle owner and/or operator, and not the vehicle manufacturer.

Unfortunately, the way that vehicle window warranty claims are conventionally handled results in the vehicle manufacturer being billed for many damaged windows that are not intended to be covered by the manufacturer warranty.

FIG. 1 is a flow chart illustrating how vehicle window warranty claims are typically handled. The customer (e.g., vehicle owner and/or operator) first discovers a glass issue with a window(s) (see step A in FIG. 1). Example glass issues (or damages) include, for example and without limitation, (i) stress or strain fractures in a vehicle window (e.g., windshield) with no obvious point of any object impact, (ii) the presence of air bubbles in the window (delamination is another potential issue), and (iii) window damage due to the impact of an object of a rock or some other hard object on the window from inside or outside the vehicle (i.e., impact damage). The customer having the glass issue visits a vehicle dealer, where the dealer writes up a warranty claim based on the glass issue (see step B in FIG. 1).

Unfortunately, vehicle dealers typically do not have glass experts or technicians on hand to determine the cause of the glass issue. Therefore, in step B of FIG. 1, no root cause of the glass issue is established. In other words, the vehicle dealer often does not attempt to (or cannot) differentiate between the different types of damage/issues (i), (ii) and (iii) discussed above. Unfortunately, this means that many types of glass issues (e.g., impact damage) not intended to be covered by the manufacturer warranty are nonetheless ultimately paid for by the vehicle manufacturer as will be shown below.

Still referring to FIG. 1, after the dealer writes up the warranty claim, a new window is needed. Typically, the vehicle manufacturer or one of its divisions (e.g., MOPAR, which is Daimler-Chrysler's Service Parts Division) orders replacement windows from a window supplier (e.g., Guardian Industries, PPG, Sekurit, Asahi, or Pilkington) (step C in FIG. 1). Vehicle manufactures (or divisions thereof) typically keep on hand a large inventory of replacement windows for its vehicles. The dealer subcontracts its services to the vehicle manufacturer (e.g., Daimler-Chrysler) (step D in FIG. 1), and is paid for the same by the vehicle manufacturer.

Glass retailers (may or may not be the dealer in different instances) typically perform the actual replacing of the vehicle window. The glass retailer orders the replacement window from the vehicle manufacturer (step E in FIG. 1), and when in receipt of the same replaces the damaged window with the new window on the customer's vehicle (step F in FIG. 1). In instances where the retailer is not the dealer, the retailer bills the dealer for the replacement fee and is paid by the dealer accordingly (step F in FIG. 1). After being billed by the retailer, the dealer submits the warranty claim to the vehicle manufacturer (step G in FIG. 1, and the vehicle manufacturer pays the dealer accordingly. The vehicle with the replacement window therein is returned to the customer (step H in FIG. 1). Thus, For purposes of example, in step C the dealer may order a new vehicle window.

Unfortunately, it can be seen that in the methodology of FIG. 1, the vehicle manufacturer often ends up paying for vehicle window warranty claims that are not intended to be covered by the manufacturer warranty. This is largely because there is no system in place for determining the true cause of the window damage (or issue) and proceeding accordingly.

Those skilled in the art will appreciate that there exists a need in the art for an improved method or technique for handling vehicle window warranty claims, and replacing windows accordingly, in a manner such that the vehicle manufacturer does not end up paying for so many window claims that are not intended to be covered by the manufacturer warranty.

### BRIEF SUMMARY OF THE INVENTION

An object of this invention is to provide a method and/or system for handling vehicle window warranty claims.

Another object of this invention is to provide a method and/or system for replacing vehicle windows in view of warranty claims thereon.

Another object of this invention is to provide a method of, in processing a warranty claim by a customer, determining the cause of the window damage and processing the warranty claim based upon the determined cause of the window damage so that the appropriate party (out of a plurality of possible parties) most often ends up paying for the replacement window.

Another object of this invention is to fulfill one or more of the above objects and/or needs.

In certain example embodiments of this invention, one or more of the above-listed objects and/or needs is/are fulfilled by providing a method of handling vehicle window warranty claims, the method comprising: a customer taking a vehicle having window damage to a retailer; a glass expert and/or technician at the retailer visually analyzing the window damage of the vehicle and making a determination as to whether the window damage is a result of activity by: (a) a vehicle manufacturer that assembled the vehicle, (b) a glass or window supplier that supplied the window to the vehicle manufacturer, or (c) the vehicle window being subject to impact damage from an object impacting the window; when (a) or (b), processing a manufacturer warranty claim from the customer relating to the window in either a first manner or a second manner different than the first manner depending upon whether the glass expert and/or technician determines (a) or (b), so that the window can be replaced under the warranty; an informing the customer that the damage is not covered by the manufacturer warranty when the glass expert and/or technician determines (c).

Certain other example embodiments of this invention fulfill one or more of the above listed objects and/or needs by providing a method handling warranty claims relating to vehicle windows, the method comprising: a customer taking a vehicle having window damage to a retailer; at least one glass expert and/or technician at the retailer visually analyzing the window damage of the vehicle and making a determination as to whether the window damage is a result of activity by: (a) a vehicle manufacturer that assembled the vehicle, (b) a glass or window supplier that supplied the window to the vehicle manufacturer, or (c) the customer who owns or operates the vehicle where the vehicle was subjected to impact damage; the retailer providing the vehicle manufacturer a listing of vehicles analyzed by the at least one glass expert and/or technician, the listing differentiating between windows damaged as a result of (a), (b), or (c).

### BRIEF DESCRIPTION OF THE DRAWINGS

FIG. 1 is a flowchart illustrating conventional steps taken in processing vehicle window warranty claims.

FIG. 2 is a flowchart illustrating steps taken in processing vehicle window warranty claims, and replacing windows accordingly, according to an embodiment of this invention.

### DETAILED DESCRIPTION EXAMPLE EMBODIMENTS OF THE INVENTION

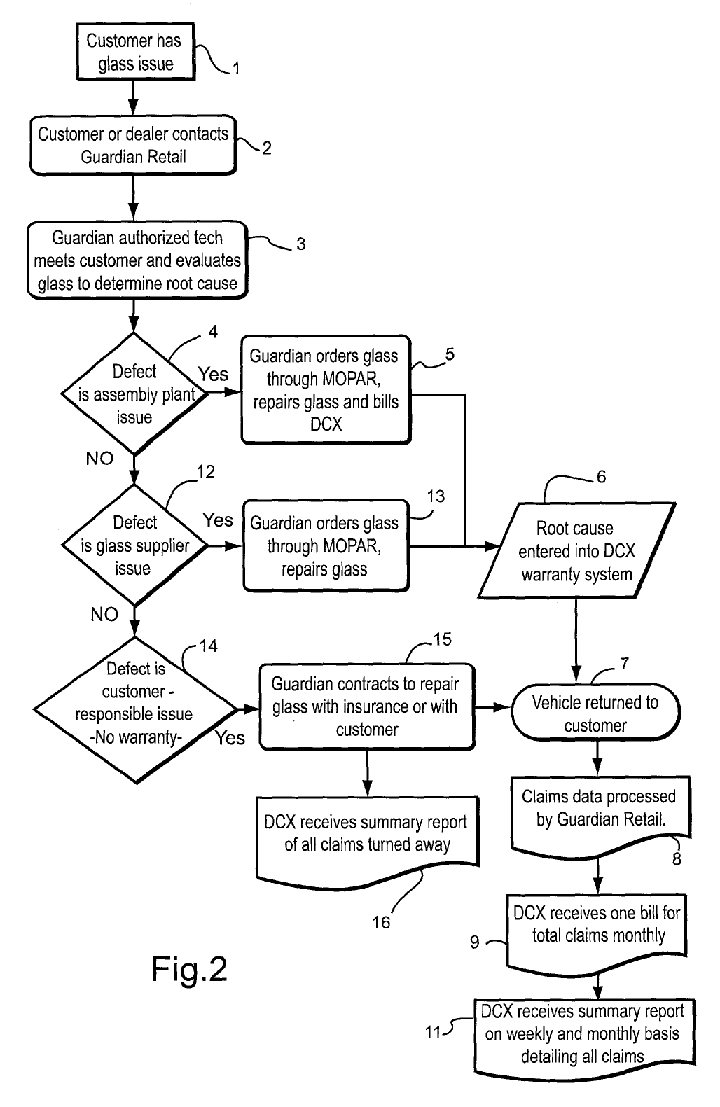

Certain example embodiments of this invention are discussed below and/or illustrated in FIG. 2. Example embodiments of this invention enable the amount of improper vehicle window warranty claims paid for by the vehicle manufacturer to be reduced. Moreover, it is noted that FIG. 2 lists Daimler-Chrysler (DCX) as an example vehicle manufacturer and Guardian as an example glass supplier/window manufacturer. Clearly, these names are provided for purposes of example only in order to simplify the explanation of example embodiments of this invention. The instant invention of course relates to other vehicle manufacturers and glass suppliers/window manufactures.

FIG. 2 a flow chart illustrating how vehicle window warranty claims are handled, and vehicle windows replaced (i.e., repaired) according to example embodiments of this invention. The customer (e.g., vehicle owner and/or operator) first discovers a glass issue with a window(s) (see step 1 in FIG. 2). The window may be a vehicle windshield, vehicle backlite and/or vehicle side window. Example glass issues (or damages) include, for example and without limitation, (i) stress or strain fractures in a vehicle window (e.g., windshield) with no obvious point of any object impact, (ii) the presence of air bubble(s) in the window, and/or (iii) window damage due to the impact of an object of a rock or some other hard object on the window from inside or outside the vehicle (i.e., impact damage). The customer having the glass issue visits and/or contacts a retailer (see step 2 in FIG. 2). The retailer may or may not include a vehicle dealer, or a glass manufacturer retail division/arm, or any other suitable entity. In FIG. 2, the retailer is listed as “Guardian Retail” for purposes of example only, and the instant invention is clearly not so limited.

A glass expert and/or technician(s) is present at the retailer to visually inspect the vehicle window having the issue/damage. The glass expert and/or technician is capable of visually analyzing the window at issue and determining the likely cause of most problems (i.e., determining the root cause of the failure). For example, the glass expert and/or technician is capable of determining whether the glass issue is a (i) stress or strain fractures in a vehicle window (e.g., windshield) with no obvious point of any object impact, (ii) air bubble(s) in the window, or (iii) window damage due to the impact of an object such as a rock or some other hard object on the window from inside or outside the vehicle (i.e., impact damage). Accordingly, when presented with the vehicle, the glass expert and/or technician at the retailer visually examines the window having the issue/damage and makes a determination as to the likely cause of the issue. For example, the glass expert may determine that the issue was caused by a rock hitting the window; or alternatively may determine that the issue was a stress or strain fracture in the vehicle window likely caused by improper installation by the vehicle manufacturer (see step 3 in FIG. 2).

If the glass expert and/or technician(s) at the retailer determines that the glass issue/damage is a vehicle manufacturer issue (e.g., issue (i) above) covered by the vehicle manufacturer warranty (see step 4 in FIG. 2), then the retailer orders a replacement window (see step 5 in FIG. 2). For example, the retailer may order the replacement window from the vehicle manufacturer or some division/arm thereof (e.g., from MOPAR as shown in FIG. 2). It is noted that this replacement window may be ordered either before of after the customer's vehicle has been repaired (i.e., the retailer may or may not have the replacement window in stock). The retailer bills the vehicle manufacturer for the repairs including but not limited to the retailer's repair services and/or the replacement window cost (see step 5 in FIG. 2). The expert/technician may be employed by the retailer, a glass supplier, and/or an overseeing administrator, or the like.

When the vehicle manufacturer is billed for or otherwise notified of the apparently proper warranty claim for the window, the cause of the window damage is entered into memory of the vehicle manufacturer warranty system (at the vehicle manufacturer or some other suitable location) (see step 6 in FIG. 2). Once the window has been repaired by the retailer (e.g., the window is replaced by the retailer), the repaired vehicle is returned to the vehicle owner/operator (i.e., customer) (see step 7 in FIG. 2). The retailer processes the warranty claim data for the window (see step 8 in FIG. 2), and sends the vehicle manufacturer a bill (e.g., a monthly bill, daily bill, or quarterly bill) for total warranty claims (see step 9 in FIG. 2). In certain example embodiments, the vehicle manufacturer may receive a summary report on a weekly, monthly and/or quarterly basis detailing all warranty claims (proper and improper) (see step 11 in FIG. 2).

It can be seen from the above that in step 4 in FIG. 2 when the glass expert/technician(s) at the retailer determines that the glass issue/damage was caused, or likely caused, by the vehicle manufacturer (e.g., a stress or strain fracture in a vehicle window with no obvious point of impact), then the vehicle manufacturer ultimately pays for the window repair (services and/or costs).

However, in step 4 of FIG. 2 when the glass expert/technician(s) at the retailer determines that the glass issue/damage was not, or not likely, caused by the vehicle manufacturer and instead it was caused by the glass or window supplier (e.g., bubbles in the window—still covered by the manufacturer warranty) (see step 12 in FIG. 2), then the retailer orders a replacement window (see step 13 in FIG. 2). For example, the retailer may order the replacement window from the vehicle manufacturer or some division/arm thereof (e.g., from MOPAR as shown in FIG. 2). It is noted that this replacement window may be ordered either before of after the customer's vehicle has been repaired (i.e., the retailer may or may not have the replacement window in stock). The retailer then repairs the customer's window (e.g., replaces the window) (see step 13 in FIG. 2). The retailer (e.g., glass shop) may then bill an administrator and/or vehicle manufacturer (or alternatively any other suitable party including but not limited to the glass supplier) for the repairs including but not limited to the retailer's repair services and/or the replacement window cost. When an administrator is billed in this regard, the administrator in turn bills the vehicle manufacturer for the same. When the vehicle manufacturer is billed for or otherwise notified of the apparently proper warranty claim for the window (due to a glass/window supplier defect), the cause of the window damage is entered into memory of the vehicle manufacturer warranty system (at the vehicle manufacturer or some other suitable location) (see step 6 in FIG. 2). Steps 7-11 are repeated. In this circumstance, when the answer to query 12 is “yes” and step 13 is performed, the vehicle manufacturer can in certain example embodiments either a) pay the bill for the repair, or b) contact the glass/window supplier and have the supplier pay for at least part of the bill for the repair or supply another window free of charge. Thus, it can be seen that in certain embodiments of this invention the warranty claim is processed in a different manner (i.e., is ultimately paid for in a different manner, listed in a different manner, or sent through different channels) based upon whether the glass issue/damage is a result of a problem with the vehicle assembly (“yes” to query 4) or a result of a defect caused by the glass/window supplier (“yes” to query 12).

However, in step 4 of FIG. 2 when the glass expert/technician(s) at the retailer determines that the glass issue/damage was not, or not likely, caused by the vehicle manufacturer, and in step 12 of FIG. 2 determines that the glass issue/damage was not, or not likely, caused by the glass/window supplier (e.g., Guardian), and instead it was caused by something not covered by the manufacturer warranty (e.g., caused by a rock hitting the windshield during vehicle operation) (see step 14 in FIG. 2), then the retailer informs the customer that the issue/damage is not covered by the manufacturer warranty. Then, if the customer desires, the retailer may contract with the customer and/or the customer's car insurance (if the customer has car insurance and elects to use it), order the replacement window (e.g., from a glass supplier such as Guardian, PPG, or the like which may or may not be related to the retailer), and repair the customer's vehicle (see step 15 in FIG. 2). In this scenario, the vehicle manufacturer is not charged for, and does not pay for, this repair since it does not properly fall under the manufacturer's warranty. Instead, either the customer and/or the customer's insurance pays the retailer for the repair (i.e., for the retailer's repair services and/or the cost of the replacement window). The retailer then sends the vehicle manufacturer a report (e.g., daily, weekly, monthly, or the like) listing and/or identifying all window warranty claims that were turned away in such a manner (see step 16 in FIG. 2). Also, steps 7-11 are repeated.

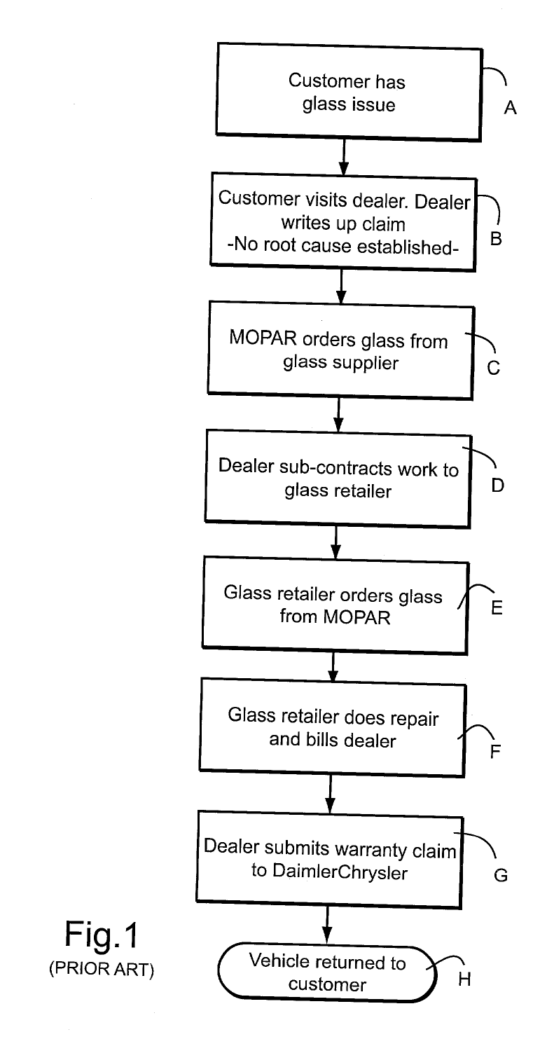

In such a manner, it is envisioned that the vehicle manufacturer may save from 30-50% of its warranty costs compared to if it used the conventional methodology of FIG. 1. This results in millions of dollars per year, which is a significant advantage over the prior art. Moreover, it is noted that in certain instances the administrator may oversee much if not all of the processing steps taken above.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A method of handling vehicle window warranty claims, the method comprising:
a customer taking a vehicle having window damage to a retailer;
a glass expert and/or technician at the retailer visually analyzing the window damage of the vehicle and making a determination as to whether the window damage is a result of activity by: (a) a vehicle manufacturer that assembled the vehicle, (b) a glass or window supplier that supplied the window to the vehicle manufacturer, or (c) the vehicle window being subject to impact damage from an object impacting the window;
when (a) or (b), processing a manufacturer warranty claim from the customer relating to the window in either a first manner or a second manner different than the first manner depending upon whether the glass expert and/or technician determines (a) or (b), so that the window can be replaced under the warranty; and
informing the customer that the damage is not covered by the manufacturer warranty when the glass expert and/or technician determines (c).

2. The method of claim 1, further comprising:
the retailer replacing the window in instances of each of (a), (b) and (c), but the retailer ordering a replacement window from a different source when the glass expert and/or technician determines (a) as opposed to (c).

3. The method of claim 1, further comprising:
the retailer replacing the window in instances of each of (a) and (b), but a different billing and/or paying procedure being carried out depending upon whether the glass expert and/or technician determines (a) or (b).

4. The method of claim 1, further comprising:
the retailer ordering a replacement window from the vehicle manufacturer when the glass expert and/or technician determines (a) or (b), and the retailer ordering a replacement window from a window supplier different than the vehicle manufacturer when the glass expert and/or technician determines (c).

5. The method of claim 1, further comprising the retailer periodically providing the vehicle manufacturer a list of all turned away warranty claims resulting from the glass expert and/or technician determining (c).

6. The method of claim 1, further comprising the retailer providing the vehicle manufacturer a listing of warranty claim attempts differentiated by at least (a), (b), and (c).

7. The method of claim 1, further comprising the vehicle manufacturer storing warranty claims in a manner so as to differentiate between claims where the glass expert and/or technician determined (a) and claims where the glass expert and/or technician determined (b).

8. A method handling warranty claims relating to vehicle windows, the method comprising:
a customer taking a vehicle having window damage to a retailer;
at least one glass expert and/or technician at the retailer visually analyzing the window damage of the vehicle and making a determination as to whether the window damage is a result of activity by: (a) a vehicle manufacturer that assembled the vehicle, (b) a glass or window supplier that supplied the window to the vehicle manufacturer, or (c) the customer who owns or operates the vehicle where the vehicle was subjected to impact damage;
the retailer providing the vehicle manufacturer a listing of vehicles analyzed by the at least one glass expert and/or technician, the listing differentiating between windows damaged as a result of (a), (b), or (c).

9. The method of claim 8, further comprising the vehicle manufacturer storing warranty claims in a manner so as to differentiate between claims where the glass expert and/or technician determined (a) and claims where the glass expert and/or technician determined (b).

10. The method of claim 8, further comprising the retailer ordering a replacement window from the vehicle manufacturer when the glass expert and/or technician determines (a) or (b), and the retailer ordering a replacement window from a window supplier different than the vehicle manufacturer when the glass expert and/or technician determines (c).

11. The method of claim 8, further comprising the retailer replacing the customer's damaged window with a replacement window.

12. A method handling warranty claims relating to vehicle windows, the method comprising:
visually analyzing window damage of a vehicle and making a determination as to whether the window damage is a result of activity by: (a) a vehicle manufacturer that assembled the vehicle, (b) a glass or window supplier that supplied the window to the vehicle manufacturer, or (c) the customer who owns or operates the vehicle where the vehicle was subjected to impact damage; and
providing the vehicle manufacturer a listing of vehicles analyzed, the listing differentiating between windows damaged as a result of (a), (b), or (c)
